(19) United States
(12) Patent Application Publication
(10) Pub. No.: US 2017/0372212 A1
(43) Pub. Date: Dec. 28, 2017

(54) MODEL BASED ROOT CAUSE ANALYSIS

(71) Applicant: CA, Inc., New York, NY (US)

(72) Inventors: Michal Zasadzinski, Olsztyn (PL); Marc Solé Simó, Barcelona (ES); Victor Muntés-Mulero, Barcelona (ES)

(21) Appl. No.: 15/195,916

(22) Filed: Jun. 28, 2016

(51) Int. Cl. G06N 7/00; G06N 99/00

(52) U.S. Cl. CPC G06N 7/005; G06N 99/005

(57) ABSTRACT

A root cause analysis system utilizes ACs corresponding to component types in a network to construct a diagnosis model. The system generates the ACs based on component models for each component type in the network and may perform offline evaluation of the ACs using determined conditional probabilities and potential state values and cache the results. When an issue is identified at a component, the system uses a relational schema to determine a set of components on which the component depends and creates a diagnosis model for performing root cause analysis. The diagnosis model includes the component type ACs corresponding to each of the components identified in the relational schema. The system populates the diagnosis model with conditional probabilities and observed state values determined from event indications generated by the components. The system outputs a most probable explanation of the issue based on evaluation of the diagnosis model.

### BACKGROUND

The disclosure generally relates to the field of computer systems, and more particularly to performing root cause analysis of system issues.

Various rule-based, model-based, statistical, machine learning, or visualization techniques can be used to perform root cause analysis. The duration and accuracy of the analysis may vary from technique to technique. To improve performance, some techniques utilize codebooks, canonical models, conditional probability tables, or precompiled Bayesian networks. Additionally, some techniques involve splitting Bayesian networks into subnetworks for faster evaluation; however, these techniques still rely on the whole Bayesian network as an underlying computational structure to maintain accuracy.

### BRIEF DESCRIPTION OF THE DRAWINGS

Aspects of the disclosure may be better understood by referencing the accompanying drawings.

FIG. 1 depicts an example system for performing root cause analysis using a diagnosis model.

FIG. 2 depicts a flow chart with example operations for performing root cause analysis using a diagnosis model.

FIG. 3 depicts a flow chart with example operations for generating a diagnosis model.

FIG. 4 illustrates an example transformation from a whole network representation to component models.

FIG. 5 illustrates an example transformation from a component model to a diagnosis model.

FIG. 6 depicts graphs illustrating performance of the above-described root cause analysis techniques in comparison to conventional approaches of model-based root cause analysis.

FIG. 7 depicts an example computer system with a root cause analyzer that includes a diagnosis model generator.

### DESCRIPTION

The description that follows includes example systems, methods, techniques, and program flows that embody aspects of the disclosure. However, it is understood that this disclosure may be practiced without these specific details. For instance, this disclosure refers to performing root cause analysis of network issues in illustrative examples. But aspects of this disclosure can be applied to fault detection in data centers and analysis of power consumption at different levels of infrastructure, such as server, rack, facility, etc. In other instances, well-known instruction instances, protocols, structures and techniques have not been shown in detail in order not to obfuscate the description.

### Terminology

The term “component” as used in the description below refers to a resource, and encompasses both hardware and software resources. The term component may refer to a physical device such as a computer, server, router, etc.; a virtualized device such as a virtual machine or virtualized network function; or software such as an application, a process of an application, database management system, etc. Also, a component may include other components or sub-components. For example, a server component may include a web service component which includes a web application component. A “component type” refers to a type of resource. A system may have thousands of components of which multiple are of type router.

The description below uses the term “component model” to refer to a probabilistic model that represents a set of variables or states of a component and conditional dependencies between those states. A component may have a variety of states or variables that are interdependent. For example, a database management system (DBMS) may have a binary state corresponding to whether the DBMS is responsive. This state may be conditionally dependent on a variable such as a query queue depth of the DBMS. A component model could represent the probabilistic relationship between the queue depth and whether the DBMS is responsive, i.e. the component model could be used to compute the probability of whether the DBMS will be responsive at a given query queue depth. This probabilistic relationship is sometimes referred to as a probability distribution. A component model may be encoded as a statistical model, such as a Bayesian network, or as an undirected, possibly cyclic graph, such as a Markov network. The nodes or vertices of these graphs represent the set of random variables or states of a component while the edges between the nodes represent the conditional dependencies. To continue the example above, the responsiveness state of the DBMS and the query queue depth may be nodes in a graph that are connected by an edge which indicates the dependency or relationship between the state and variable.

The description below uses the term “arithmetic circuits” to refer to a model for computing polynomials. An arithmetic circuit (“AC”) is typically depicted as a directed acyclic graph wherein the nodes of the graph include the arguments and operands for a polynomial. The size and depth of the AC can be indicative of the complexity of computing the polynomial. The ACs as discussed below are maximizer circuits designed for calculating a most probable explanation. In maximizer circuits, addition operation nodes are replaced with maximum operation nodes so that the circuit only contains maximum and multiply operation nodes. An AC may also be referred to as a probabilistic model.

Component models and arithmetic circuits may be indicated with data structures such as a graph data structure, JavaScript Object Notation (JSON) objects, extensible markup language (XML) files, Universal Modelling Language (UML), etc. In some implementations, a polynomial for an AC may be stored as an equation and may be converted to a graph or tree data structure on demand for evaluation.

The description below refers to an indication of an event (“event indication”) to describe a message or notification of an event. An event is an occurrence in a system or in a component of the system at a point in time. An event often relates to resource consumption and/or state of a system or system component. As examples, an event may be that a file was added to a file system, that a number of users of an application exceeds a threshold number of users, that an amount of available memory falls below a memory amount threshold, or that a component stopped responding or failed. An event indication can reference or include information about the event and is communicated by an agent or probe to a component/agent/process that processes event indications. Example information about an event includes an event type/code, application identifier, time of the event, severity level, event identifier, event description, etc.

Overview

The proliferation of network connected components, such as Internet of Things (IoT) devices has led to dynamically changing networks, i.e. components are frequently introduced or removed from the network. Performing root cause analysis on these dynamic networks is especially problematic when using probabilistic relational models because the model must be modified to account for the changing network conditions. Maintaining and evaluating a probabilistic relational model for an entire network can be slow and costly for computational resources. To reduce the evaluation time and resources, a root cause analysis system utilizes ACs corresponding to component types in a network to construct a diagnosis model. The system generates the ACs based on component models for each component type in the network. The system may perform offline evaluation of the ACs using determined conditional probabilities and potential state values and cache the results. When an issue is identified at a component, the system uses a relational schema to determine a set of components on which the component depends and creates a diagnosis model for performing root cause analysis of the issue. The diagnosis model includes the component type ACs corresponding to each of the components identified in the relational schema. Since the diagnosis model is limited to the set of components on which the issue component depends, the system avoids evaluation of a whole network model each time root cause analysis is performed. To evaluate the diagnosis model, the system populates the diagnosis model with conditional probabilities and observed state values determined from event indications generated by the components. Additionally, the system may reduce the time of evaluating the diagnosis model by utilizing the pre-evaluated, cached values of the ACs. The system outputs a most probable explanation of the issue based on evaluation of the diagnosis model.

Example Illustrations

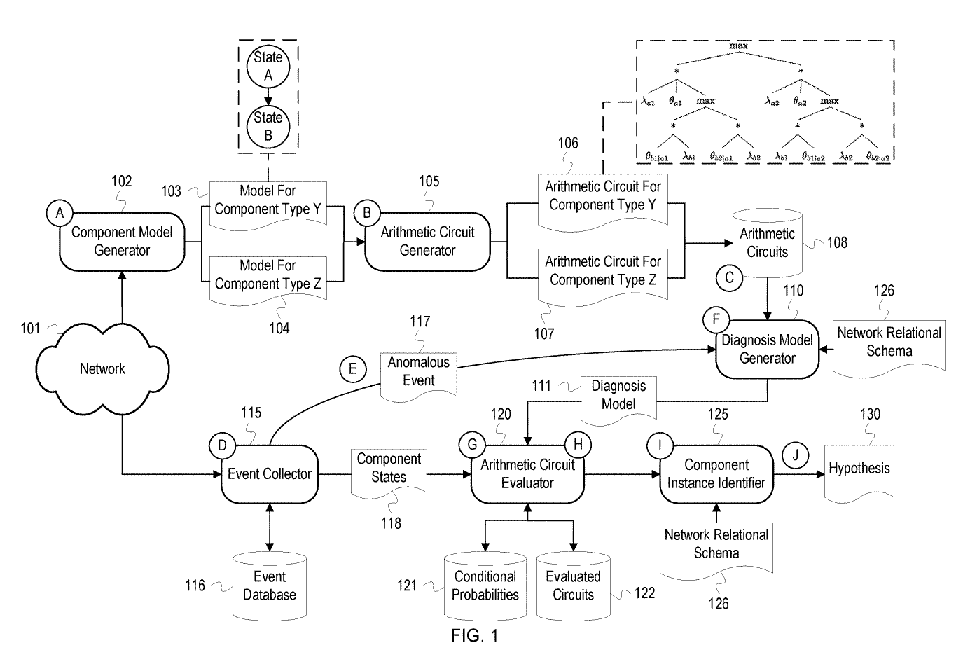

FIG. 1 is annotated with a series of letters A-H. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

FIG. 1 depicts an example system for performing root cause analysis using a diagnosis model. FIG. 1 depicts a network 101, a component model generator 102, an arithmetic circuit generator 105, a diagnosis model generator 110, an event collector 115, an arithmetic circuit evaluator 120, and a component instance identifier 125. The arithmetic circuit generator 105 and the diagnosis model 110 are communicatively coupled to an arithmetic circuits database 108. The event collector 115 is communicatively coupled to an event database 116. The arithmetic circuit evaluator 120 is communicatively coupled to a conditional probabilities database 121 and an evaluated circuits database 122.

Stages A-C may be performed while the example system is offline, i.e. not currently performing root cause analysis. At stage A, the component model generator 102 generates component models for each type of component in the network 101. The components may be a variety of types of hardware resources, such as hosts, servers, routers, switches, databases, IoT devices, sensors, etc., or types of software resources, such as web servers, virtual machines, applications, programs, processes, database management systems, etc. In FIG. 1, the network 101 includes components of a component type Y and components of a component type Z (not depicted). The component model generator 102 may identify component types based on a network topology or a network relational schema 126. The network relational schema 126 identifies components and interconnections or dependencies among the components. For example, the network relational schema 126 may indicate that the network 101 includes ten instances of each of the components Y and Z and that each component of type Y depends on a component of type Z. The network relational schema 126 may be generated manually or by software that identifies components and their interconnections within a network, such as software that polls devices using Simple Network Management Protocol (SNMP). In some implementations, the component model generator 102 may identify individual component types within a previously generated Bayesian network or similar description of components in the network 101. The component model generator 102 may analyze the Bayesian network which represents components in the network 101 to identify groups or clusters of related nodes/states. The component model generator 102 then may identify repetitive node groups as a specific component type for which a component model is created.

In FIG. 1, the component model generator 102 generates a model for component type Y 103 and a model for component type Z 104 (“the component models”). The component models represent the states of the component types Y and Z and the conditional dependencies between those states. Additionally, the component models include states or variables from other components which are inputs into one or more states of a component model. FIG. 1 depicts one example of the model for component type Y 103. The component Y may include a single state B. However, the model for component type Y 103 includes a state A and the state B and a conditional dependency (directed arrow) that indicates that the state B depends on the value of state A. The input of state A into the state of the component Y is included so that an arithmetic circuit generated based on the model for component type Y 103 may be evaluated along with the inputs. A node or input that is external to the component may be flagged or marked as an external node. These references to states external to the component type allow for later aggregation of the various ACs generated based on the component models and compilation into a diagnosis model.

At stage B, the AC generator 105 generates an AC for component type Y 106 and an AC for component type Z 107 based on the component models. The AC generator 105 generates ACs that are designed to produce a most probable explanation of a state or anomalous event in the network 101. Such an AC, sometimes referred to as a maximizer circuit, includes “max” operation nodes that cause a maximum of two determined values to be selected in place of addition nodes, which causes two values to be added. FIG. 1 illustrates an example of the AC for component type Y 106. After generating the AC for component type Y 106 and the AC for component type Z 107, the AC generator 105 stores the ACs in the AC database 108 for future use. The AC database 108 stores ACs for each component type in the network 101.

At stage C, the arithmetic circuit evaluator 120 performs offline evaluation of the ACs in the AC database 108 using sets of potential state or variable values. The arithmetic circuit evaluator 120 may prioritize the evaluation of ACs which are computationally intensive, and therefore time-consuming to evaluate, such as ACs with a large size or depth or a large number of edges and nodes. The arithmetic circuit evaluator 120 stores the results of evaluating the ACs in the evaluated circuits 122 along with an identifier for the component type or evaluated AC and an indication of the set of state or variable values used to evaluate the AC.

Stages D-J may be performed while the example system is online, i.e. performing root cause analysis. At stage D, the event collector 115 receives event indications from the components of the network 101. The components either directly or via monitoring agents generate event indications that are received by the event collector 115. The components are instrumented with agents or probes that monitor the components and generate event indications that specify or otherwise describe events that occur at or in association with one of the components. For example, an event indication may indicate an action performed by a component such as invoking another component, storing data, restarting, etc. Event indications may also be used to report states or variables of a component, such as whether the component is operational, and recorded measurements, such as available memory, processor load, storage space, network traffic, etc.

At stage E, the event collector 115 receives an indication of an anomalous event 117 from a component (not depicted) in the network 101. An anomalous event is an event that indicates a network occurrence or condition that deviates from a normal or expected value or outcome. For example, the anomalous event 117 may indicate that the component in the network 101 is not responding or that the component is experiencing an amount of network traffic that exceeds a specified threshold. In response to receiving the anomalous event 117, the event collector 115 forwards the anomalous event 117 to the diagnosis model generator 110.

At stage F, the diagnosis model generator 110 generates a diagnosis model 111 for analysis of the anomalous event 117. The diagnosis model generator 110 analyzes the indication of the anomalous event 117 to identify a component experiencing the anomaly or issue. The anomalous component may be the component which generated the anomalous event 117, or the anomalous event 117 indication may identify a component which was non-responsive or otherwise responded anomalously in an interaction with another component that generated the anomalous event 117. Once the anomalous component is identified, the diagnosis model generator 110 uses the network relational schema 126 to identify components on which the component depends. The components on which the anomalous component depends are components whose states or variables affect states or variables of the anomalous component. The diagnosis model generator 110 then determines the types of the anomalous component and the components on which the anomalous component depends. The diagnosis model generator 110 then retrieves the ACs corresponding to the component types for each of the components from the AC database 108. In some implementations, the diagnosis model generator 110 retrieves the AC corresponding to the anomalous component type from the AC database 108 and uses the external nodes identified in the AC to determine the components on which the anomalous component depends. For example, the diagnosis model generator 110 may determine that the anomalous component is of the type Y and retrieve the AC for component type Y 106. The diagnosis model generator 110 then identifies the external input node A in the AC for component type Y 106. The diagnosis model generator 110 determines the component type corresponding to the node A and retrieves the associated AC from the AC database 108. The diagnosis model generator 110 iteratively performs this process, i.e. the diagnosis model generator 110 retrieves the AC corresponding to the type of component for node A and determines whether the AC indicates any external input nodes. This process continues until each dependent component or a threshold number of dependent components are discovered.

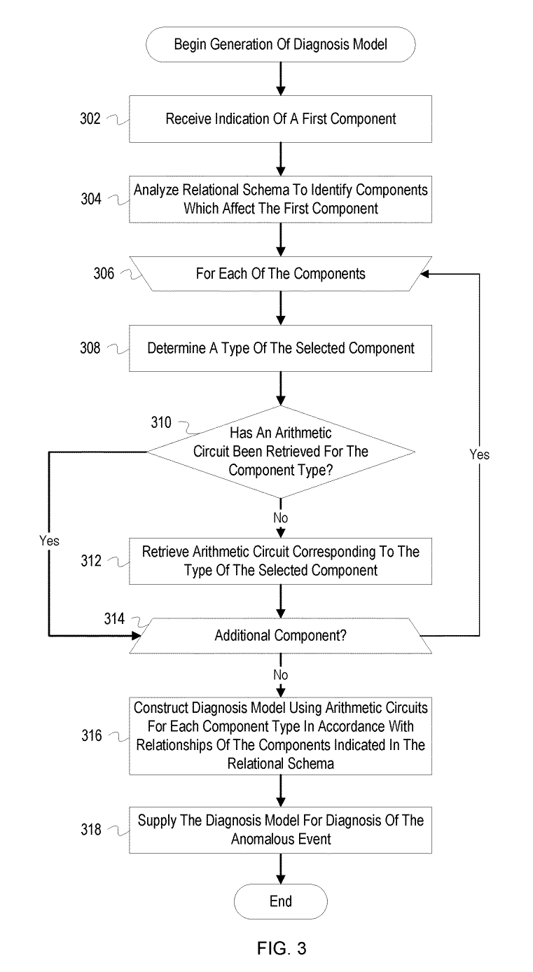

Once the diagnosis model generator 110 has retrieved ACs corresponding to each of the component types, the diagnosis model generator 110 constructs the diagnosis model 111 using the ACs. The diagnosis model generator 110 determines a number, type, and location of components in the network relational schema 126 and constructs the diagnosis model 111 by inserting the ACs in the corresponding locations. For example, the diagnosis model generator 110 may determine from the network relational schema 126 that the issue component depends on two components of type Z. The diagnosis model generator 110 constructs the diagnosis model 111 by replicating the AC for component type Z 107 and inserting the replicated ACs as inputs into an AC for the issue component. Since the AC for the issue component includes nodes for external inputs, the two ACs for component type Z 107 may be inserted by replacing the external input nodes with the root nodes of the two ACs for component type Z 107. The construction of a diagnosis model is explained in more detail in FIG. 3. In some implementations, the diagnosis model generator 110 may not construct the ACs into the diagnosis model 111. Instead, the diagnosis model generator 110 may identify and retrieve the ACs corresponding to the component types and forward the ACs to the arithmetic circuit evaluator 120.

At stage G, the arithmetic circuit evaluator 120 retrieves values for evaluating the diagnosis model 111. As illustrated in the example of the AC for component type Y 106, an AC takes as inputs values of conditional probabilities and states or variables of a component. The conditional probability values (sometimes referred to as network parameters) in the AC for component type Y 106 are depicted with the theta symbol “θ” and the state values (sometimes referred to as evidence) with the lambda symbol “λ”. The arithmetic circuit evaluator 120 requests the state values from the event collector 115 using the identifiers for the set of components. The event collector 115 responds with the component states 118. The arithmetic circuit evaluator 120 retrieves the conditional probabilities for each component type from the conditional probabilities database 121.

At stage H, the arithmetic circuit evaluator 120 evaluates the diagnosis model 111. The arithmetic circuit evaluator 120 may first search the evaluated circuits 122 to determine whether any ACs corresponding to the set of component types and the given component states 118 have been pre-evaluated or computed offline and cached. The arithmetic circuit evaluator 120 may identify the relevant cached results by searching the evaluated circuits 122 with an identifier for a component type and a set of state values. The arithmetic circuit evaluator 120 can then use the results when evaluating the diagnosis model 111 to decrease a total amount of evaluation time.

For ACs whose values were not pre-cached in the evaluated circuits 122, the arithmetic circuit evaluator 120 evaluates the diagnosis model 111 by inputting the values retrieved at stage F into the ACs of the diagnosis model 111 and performing the operations indicated by the operational nodes of the ACs. As described above, in some implementations, the arithmetic circuit evaluator 120 receives the individual arithmetic circuits corresponding to the related component types without assembly into the diagnosis model 111. In such implementations, the arithmetic circuit evaluator 120 may use the network relational schema 126 to identify a set of components related to the anomalous event 117. The arithmetic circuit evaluator 120 may then iteratively evaluate each component in the set of components using the corresponding data in the component states 118 and the conditional probabilities database 121 and aggregate the results of each evaluation as they are performed. The result of evaluating the diagnosis model 111 is a most probable explanation of the anomalous event 117. The most probable explanation may identify a particular component type or states of a component that contributed to the anomalous event.

At stage I, the component instance identifier 125 identifies an instance of a component(s) suspected as causing the anomalous event 117 based on output of the arithmetic circuit evaluator 120. The component instance identifier 125 may determine the instance(s) from the diagnosis model 111 or may analyze the network relational schema 126 to retrieve identifiers for the issue component(s). At stage J, the component instance identifier 125 outputs a hypothesis 130 for the anomalous event 117. The hypothesis 130 includes identifiers for instances of the component(s) identified at stage I. The hypothesis 130 may also indicate particular state or variable values that contributed to the occurrence of the anomalous event 117.

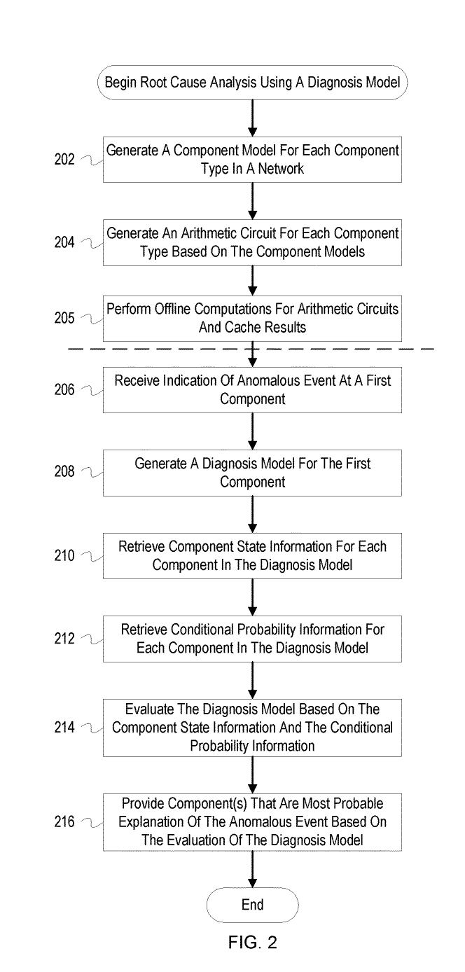

FIG. 2 depicts a flow chart with example operations for performing root cause analysis using a diagnosis model. FIG. 2 refers to a root cause analyzer similar to the example root cause analyzer system described in FIG. 1 as performing the operations even though identification of program code can vary by developer, language, platform, etc.

A root cause analyzer (“analyzer”) generates a component model for each component type in a network (202). A component model represents various potential states or variables of a component and the interdependencies among the states. In some implementations, a user may manually input component models for each type of component in a network or a system for use by the analyzer. In other implementations, the analyzer may generate a component model based on an analysis of events generated by a component or an agent of the component. For example, the analyzer may determine that a component of a particular component type generates event indications which indicate the component's temperature and event indications that indicate whether the component is operational. Based on identification of these events, the analyzer generates a component model for the component type that contains two nodes: a first node to indicate whether the temperature is above or below a threshold and a second node to indicate whether the component is operational. The analyzer may also add a unidirectional edge from the first node to the second node to indicate that whether the component is operational can be affected by whether the temperature exceeds a threshold.

The component model for each component type is modified to include inputs from other component types. Similar to the example above, a server component type may have a single state corresponding to whether the server is operational, and a temperature sensor component type may include a state that indicates whether a temperature of the server or a room that contains the server exceeds a threshold. As a result, a component model for the server component type may include the operational state for the server and the state from the temperature sensor as an input into the operational state. Because the inputs are included in the component model, an AC generated based on the component model reflects inputs or variables on which the states of the component type depend.

The analyzer generates an AC for each component type based on the component models (204). The analyzer determines a multi-linear function that represents the component model. For example, if the component model is a Bayesian network with two states A and B, the multi-linear function may be represented as follows:

$$f = {\sum }_{b} {\prod }_{ba ∼ b} {λ}_{b} {θ}_{b \vert a}$$

where λ_{b} denotes a value for state B and θ_{b|a} stands for parameters associated with conditional probabilities of state B depending on state A

The multi-linear function is transformed into an AC to facilitate calculations, such as Bayesian inference calculations. Additionally, the AC is converted into a maximizer circuit by replacing addition operation nodes with maximum operation nodes. In some implementations, generating the ACs based on the component models may involve intermediate data structures. For example, the analyzer may first generate a jointree based on the component model and then generate an AC based on the jointree. Once the ACs are generated, the analyzer stores the ACs along with corresponding component type identifiers in storage, such as memory of a system executing the analyzer or a database.

The analyzer performs offline calculations for the ACs and caches the results (205). While the analyzer is not performing root cause analysis, the analyzer may pre-evaluate the ACs and cache the results so that later root cause analysis can be performed more quickly by using the cached results. The analyzer populates the ACs with potential state and variable values and values for conditional probabilities retrieved from a conditional probability database. The analyzer then stores the results of the evaluated ACs along with the state values that were used to calculate the result. For example, if evaluating an AC for a two state component model, the analyzer may plug in a value of 1 for a state A and a value of 0 for a state B and arrive at a result of 0.55. The analyzer may store the result 0.55 in a table along with the values of 1 and 0 for states A and B, respectively. When later evaluating the AC during root cause analysis, the analyzer may search the table with the actual observed values of states A and B to retrieve the pre-evaluated result, thus eliminating the computational time of evaluating the AC.

The analyzer receives an indication of an anomalous event at a first component (206). The analyzer may receive the event indication from an event management system configured to identify and forward anomalous events to the analyzer. Alternatively, the analyzer may monitor an event database and process event indications to determine if an anomalous event is indicated. The analyzer may monitor for a particular event type or may compare event attribute values to expected values or thresholds. The event indication at least includes an identifier for the first component and may also indicate a component type of the first component, a time of the anomalous event and an attribute value associated with the event, such as a response time or processor load.

In response to receiving the anomalous event indication, the analyzer generates a diagnosis model for the first component (208). The analyzer determines components on which the first component depends from a network or system relational schema or topology. The analyzer determines the component types of the components and retrieves the ACs corresponding to each of the component types. The analyzer then constructs the diagnosis model using the ACs and the relational schema. The operations for constructing the diagnosis model are described in more detail in FIG. 3.

The analyzer retrieves component state information for each component in the diagnosis model (210). The analyzer determines identifiers for the first component and each of the components on which the first component depends from the relational schema. The analyzer uses the identifiers to query an event database to retrieve event indications which indicate state information for each of the components. The analyzer may determine the state information by identifying event types corresponding to a particular state or variable. For example, if the analyzer is attempting to determine whether a component is operational, the analyzer may search for event types related to a boot up or shut down indication of a device or an event that indicates whether a device responded to polling. The analyzer may filter the event database to identify event indications for events occurring within a time period corresponding to a time of the anomalous event so that state information for the time at which the anomalous event occurred can be determined. In some instances, the analyzer may compare event attributes values to a threshold associated with a state to determine the state value. For example, a state for a component may have a value of 1 if the processor load for a component exceeds a threshold and a value of 0 if the process load does not. The analyzer compares a processor load value retrieved from an event indication for the component to the threshold to determine the value of the state.

The analyzer retrieves conditional probability information for each component in the diagnosis model (212). The analyzer may determine the conditional probabilities based on correlating events for the network. The analyzer may correlate events based on a statistical, causal, or probability analysis. For example, the analyzer may determine a product-moment correlation coefficient to measure a linear correlation between two events or attributes of those events. Based on an occurrence rate of the correlation in an event log, the analyzer may determine a conditional probability that a first component or a state or variable of the first component affects a second component. In some implementations, the conditional probability information is manually input by a user, such as a network administrator. The analyzer maintains the conditional probabilities in a database or other persistent storage and associates the conditional probabilities with a corresponding identifier for a component type as well as corresponding state information, as a conditional probability is associated with a state of a component. Alternatively, in some implementations, the conditional probability information may be maintained within an AC for a component type.

The analyzer evaluates the diagnosis model based on the component state information and the conditional probability information (214). The analyzer populates the ACs of the diagnosis model with the corresponding values. As mentioned above, the analyzer may have pre-evaluated at least some of the ACs, so prior to evaluating the diagnosis model, the analyzer may search the cached AC results using determined state information for the components. The analyzer may then simplify the diagnosis model by substituting component ACs with the cached result values. The analyzer then evaluates the remainder of the diagnosis model to produce a final diagnosis or a most probable explanation of the anomalous event. The analyzer may evaluate the diagnosis model using program code similar to the following pseudo-code:

### Notation

I=single instance of a component
I.S=nodes in instance I which are referenced by nodes from other instances
I.P=nodes in instance I which are external nodes from other instances I′
I′=an instance I from which a node p was cloned
p.v=value of a node p which is an external node from an instance I′ that was cloned in the instance I

### Pseudo-Code

### Inputs:

Component type ACs AC, relevant components II, state values e, conditional probabilities c;

starting with instances I where I.S=0;
for each I in II do

key=(type(I), e, c);

if cache contains value for key then
result=cache[key];

else
result=evaluate AC[type(I)] with e and c and any p.v;
put result in cache[key];
for each node p in I.P do
   send p.v to referenced node s in I′ for evaluating I′.

In the example pseudo-code above, the analyzer iterates over each component instance in the relevant components H. The relevant components include the first component and the components on which the first component depends. The analyzer begins iterating over component instances I where I.S=0, i.e. instances that do not include nodes that are referenced by nodes of other instances. For each instance, the analyzer determines a key that is used to search the cached results. The key comprises the component type of the instance, the state values for the instance, and the conditional probabilities for the instance. If the analyzer determines that the cache contains a result based on the key, the analyzer determines that the result for the instance's AC within the diagnosis model is equal to the cached value. If the result is not cached, the analyzer proceeds to evaluate the AC corresponding to the component type of the instance I using the state values, conditional probabilities, and any p.v values and then caches the result for future use. The p.v values are values that were determined as a result of evaluating an AC for another instance. When evaluating an instance with p nodes, the analyzer iterates over each of the p nodes and preserves the value of the nodes for evaluation of other instances that refer to the p nodes.

The analyzer provides component(s) and/or component(s) states that are the most probable explanation of the anomalous event based on the evaluation of the diagnosis model (216). The analyzer may display the information in a graphical user interface of network management software that depicts identifiers for the likely issue components and as well as state information for the components. Additionally, the analyzer may propose a diagnosis, such as “server most likely failed because the temperature sensor reported a temperature of 100 degrees.”

The operations of blocks 202-205 may occur independently of the operations of blocks 206-216 as indicated by the dashed line in FIG. 2. The operations of blocks 206-216 may be repeated each time an anomalous event is received. Additionally, multiple instances of the operations may execute in parallel as anomalous events are received. In some implementations, instead of an anomalous event, the operations may be triggered by receipt of an identifier for a component, by a network administrator running hypothetical models, etc. The operations of blocks 202-205 may be performed periodically or as new components are added to a network. Additionally, performing offline computations for ACs (205) may be performed in response to changes in a component model or changes in conditional probability values.

FIG. 3 depicts a flow chart with example operations for generating a diagnosis model. FIG. 3 refers to a root cause analyzer similar to the example root cause analyzer system described in FIG. 1 as performing the operations even though identification of program code can vary by developer, language, platform, etc.

A root cause analyzer (“analyzer”) receives an indication of a first component (302). The indication of the first component includes an identifier for the first component and may include state information for the first component. The analyzer may receive the indication of the first component from another module in a root cause analysis system or network or may receive the indication along with an anomalous event in a manner similar to that indicated at block 206 of FIG. 2.

The analyzer analyzes a relational schema to identify components which affect the first component (304). The analyzer uses the identifier for the first component to identify an entry for the first component in the relational schema. Based on the relational schema, the analyzer identifies components on which the first component depends. The analyzer iteratively analyzes the relational schema to identify the hierarchy of dependent components. For example, if the analyzer identifies that the first component depends on a component A, the analyzer determines the components on which the component A depends and continues until all dependent components, or a threshold number of dependent components, have been identified. In some implementations, the analyzer may construct a tree data structure with the first component as a root node to track the components on which the first component depends. Each node of the tree may include a component identifier and a component type.

The analyzer performs operations for each of the components including the first component (306). The component for which operations are currently being performed is hereinafter referred to as “the selected component.”

The analyzer determines a type of the selected component (308). The type of the component may be indicated in the relational schema. Alternatively, the analyzer may search a configuration management database with an identifier for the selected component to identify a component type or may determine the type of the selected component by parsing the identifier for the selected component. For example, the identifier may be “PC01” from which the analyzer may determine that the component type is “PC.”

The analyzer determines whether an AC has been retrieved for the component type (310). As ACs are retrieved, the analyzer may maintain a list of component types for which ACs have been retrieved. If an AC corresponding to the component type has not been retrieved, the analyzer retrieves an AC corresponding to the type of the selected component (312). The analyzer may use an identifier for the component type to retrieve the AC from a catalog or database of ACs.

If an AC corresponding to the component type has been retrieved or after retrieving the AC, the analyzer determines whether there is an additional component (314). If there is an additional component, the analyzer selects the next component (306).

If there is not an additional component, the analyzer constructs a diagnosis model using the ACs for each component type in accordance with relationships of the components indicated in the relational schema (316). The ACs are located within the diagnosis model corresponding to the component dependencies indicated by the relational schema. For example, if the first component is dependent on three components of a second type, the diagnosis model consists of the AC for the first component with three instances of the AC for the second component type as inputs into the AC of the first component type. Because the ACs were created based on component models that included inputs from dependent components, the ACs include nodes that allow for the inputs from the root nodes of the dependent component ACs. If the analyzer created a tree data structure representing the component dependencies, the analyzer may replace or supplement each node in the tree with the AC corresponding to the component type to create the diagnosis model.

In some implementations, the analyzer constructs the diagnosis model by linking output nodes of ACs to corresponding input nodes of other ACs. For example, if a first AC outputs a value that is an input to a second AC, the analyzer links the output from the first AC to the input of the second AC. The nodes are linked in response to determining that a component is dependent upon or affected by another component. The analyzer may link the nodes by adding a pointer to an output node that points to the input node or connecting the nodes in a tree data structure. Additionally, the analyzer may assign identifiers to instances of ACs in the diagnosis model and maintain an entry for an AC that includes the identifiers of ACs that are inputs into the AC.

The analyzer supplies the diagnosis model for diagnosis of the anomalous event (318). The diagnosis model may be supplied to another module of a root cause analysis system for determining a most probable explanation of issues or anomalies at the first component. Additionally, the analyzer may cache or store the diagnosis model or the tree data structure representing the diagnosis model for future use. In some implementations, the analyzer may optimize or simplify the diagnosis model prior to supplying it. For example, the analyzer may perform a tree reduction on the diagnosis model.

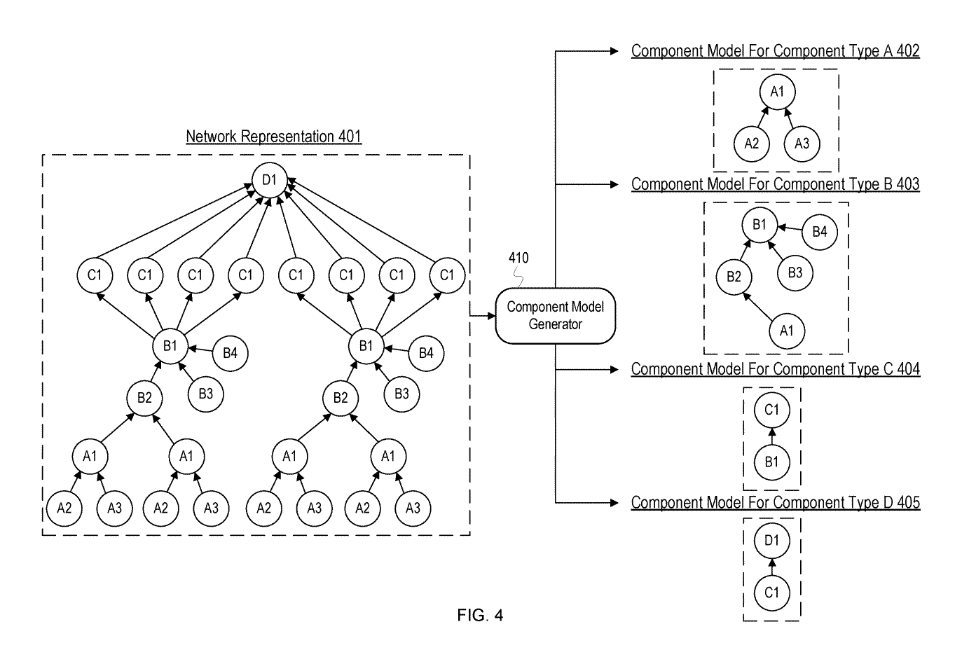

FIG. 4 illustrates an example transformation from a whole network representation to component models. FIG. 4 depicts a network representation 401, a component model for a component type A 402 (“component model A 402”), a component model for a component type B 403 (“component model B 403”), a component model for a component type C 404 (“component model C 404”), and a component model for a component type D 405 (“component model D 405”). FIG. 4 also depicts a component model generator 410 (“generator 410”) which generates the component models.

The network representation 401 is depicted as a Bayesian network but, in some implementations, may be a Markov network or other representation. The network representation 401 depicts states and variables of multiple component types and instances of each component type within a network. In FIG. 4, the network representation 401 depicts the different component types with letters with numbers indicating different stages. For example, a component type A includes three stages, A1, A2, and A3. Although the network representation 401 indicates the different component types, in some instances, a network representation may not clearly delineate component types. In such instances, the component model generator 410 may analyze a network representation to identify repeating patterns of states and identify unique patterns as component types.

The generator 410 generates a component model for each component type in the network. The generator 410 generates component models in a manner similar to that described in FIG. 1. By generating a component model for each type instead of each component instance, the generator 410 reduces the amount of memory needed to store models for components in the network representation 401. Additionally, the generator 410, and a root cause analysis system incorporating the generator 410, can more easily respond to changing network conditions. For example, if an additional component of component type B is added, the generator 410 does not need to generate a new model as a model already exists for component of type B. If fifty components of a new component type are added to the network, the generator 410 generates a single model to represent the component type, thus alleviating the need to generate fifty models.

The component model A 402 includes three nodes that represent the three states of the component type A and does not include any external nodes since none of the states in the component type A receive an input from another component type. The component model B 403 includes four nodes for the component type B states as well as an external node A1 since the state A1 of the component type A affects the state B2 of the component type B. The component model generator 410 may include a reference in the node A1 in the component model B 403 to the node A1 in the component model A 402 to allow for aggregating state values during evaluation of ACs representing the component model B 403. Even though two A1 states affect the state B2, the component model generator 410 may indicate one external node in the component model B 403 to represent the similar external states. During evaluation of an AC for the component model B 403, multiple values for state A1 may be aggregated and input into the AC. The component model C 404 includes the state C1 and the external state B1 from the component type B. Similarly, the component type D 405 includes the state D1 and a single node to represent external states of type C1.

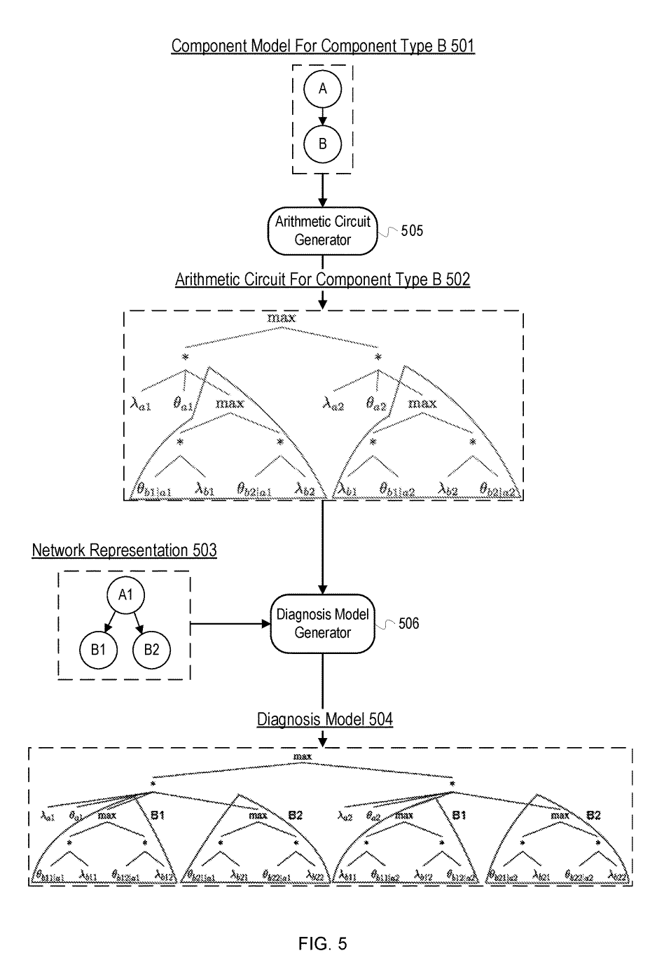

FIG. 5 illustrates an example transformation from a component model to a diagnosis model. FIG. 5 depicts a component model for a component type B 501 (“component model 501”), an AC for a component type B 502 (“AC 502”), a network representation 503, and a diagnosis model 504. The component model 501 may have been generated by a component model generator such as the component model generator 102 of FIG. 1. FIG. 5 also depicts an AC generator 505 and a diagnosis model generator 506. The AC generator 505 generates the AC 502 based on the component model 501 in a manner similar to that of the AC generator 105, and the diagnosis model generator 506 generates the diagnosis model 504 in a manner similar to that of the diagnosis model generator 110 of FIG. 1.

The component model 501 includes a node B that receives an input from a node A. The component model 501 was modified to include external nodes that are inputs into the component type B. The node A represents a state of a component type A that affects the component type B. A multi-linear function is generated for the component model 501 and transformed into the AC 502. The AC 502 in FIG. 5 is marked to indicate the portions of the AC 502 corresponding to the B node.

The network representation 503 represents a network for which root cause analysis is being performed. The network representation 503 indicates that the network includes an instance of the component type A (A1) which affects two instances of the component type B (B1 and B2). The network representation 503 is used to construct the diagnosis model 504. ACs corresponding to the component types of the component instances indicated in the network representation 503 are assembled in a manner corresponding to the relationships indicated in the network representation 503. In FIG. 5, the AC 502 representing the component type A is retrieved. Additionally, the portions of the AC 502 corresponding to an AC for a component type B are replicated to reflect that two instances of the component type B depend on the component instance A1. The resulting diagnosis model 504 may be used to perform diagnosis of issues in the network represented by the network representation 503.

FIG. 5 illustrates examples of the component model 501, the AC 502, network representation 503, and the diagnosis model 504. These graphical illustrations represent data structures that may be used to denote these elements, such as trees and graphs. However, these elements may also be represented by other data structures. For example, the component model 501 and the network representation 503 may be described using UML. Additionally, the AC 502 and the diagnosis model 504 may be written out as a mathematical equation.

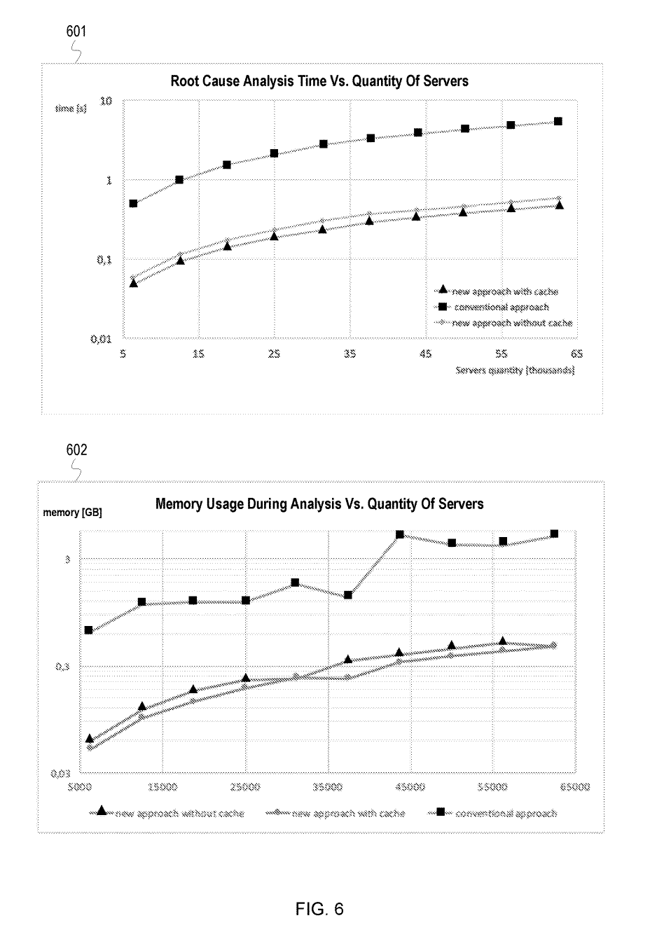

FIG. 6 depicts graphs illustrating performance of the above-described root cause analysis techniques in comparison to conventional approaches of model-based root cause analysis. The graphs are based on performing root cause analysis in an example Bayesian network that includes a number of servers. The example network also includes server racks, zones, and rooms that increase in number as the quantity of servers are increased. FIG. 6 depicts an analysis time graph 601 showing a root cause analysis time (in seconds) versus a quantity of servers (in thousands) in the example network. The analysis time graph 601 includes three lines: a first line for the above-described technique that utilizes a cache (indicated with triangles), a second line for a conventional approach (indicated with squares), and a third line for the above-described technique that does not utilize a cache (indicated with circles). As can be seen in the graph 601, the above-described technique exhibits approximately 10 times better performance in comparison to the conventional approach. FIG. 6 also depicts a memory usage graph 602 showing memory usage during analysis (gigabytes) versus a quantity of servers in the example network. Again, the memory usage graph 602 indicates that the above-described technique exhibits approximately 10 times better performance in comparison to a conventional approach. As the quantity of servers increases, the conventional approach consumes over three gigabytes of memory, while the above-described technique consumes just over 0.3 gigabytes of memory. This savings in memory can likely be attributed to the use of component models which avoids storing and creating ACs and models for all component instances in a network.

### VARIATIONS

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in block 316 of FIG. 3 can be performed concurrently as part of the iterative operations beginning at block 306 of FIG. 3. Additionally, the operations depicted in block 205 of FIG. 2 may not be performed. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

The variations described above do not encompass all possible variations, implementations, or embodiments of the present disclosure. Other variations, modifications, additions, and improvements are possible. As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

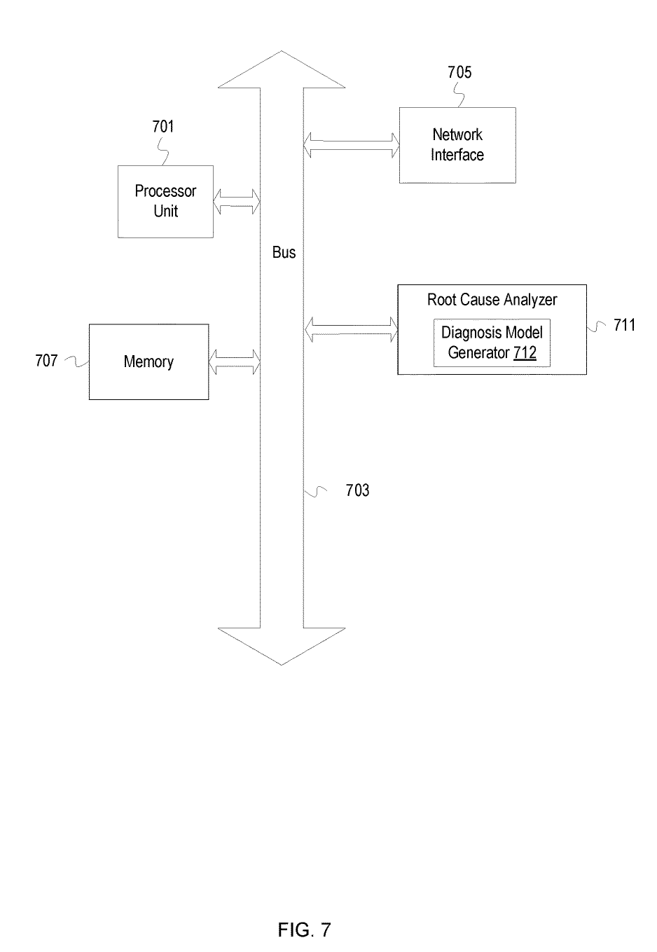

FIG. 7 depicts an example computer system with a root cause analyzer that includes a diagnosis model generator. The computer system includes a processor unit 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport® bus, InfiniBand® bus, NuBus, etc.) and a network interface 705 (e.g., a Fiber Channel interface, an Ethernet interface, an internet small computer system interface, SONET interface, wireless interface, etc.). The system also includes a root cause analyzer 711 which includes a diagnosis model generator 712. The root cause analyzer 711 diagnoses a network issue based on evaluation of a diagnosis model generated by the diagnosis model generator 712. The diagnosis model generator 712 uses a network relational schema and ACs corresponding to component types to generate the diagnosis model. Any one of the previously described functionalities may be partially (or entirely) implemented in hardware and/or on the processor unit 701. For example, the functionality may be implemented with an application specific integrated circuit, in logic implemented in the processor unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701 and the network interface 705 are coupled to the bus 703. Although illustrated as being coupled to the bus 703, the memory 707 may be coupled to the processor unit 701.

While the aspects of the disclosure are described with reference to various implementations and exploitations, it will be understood that these aspects are illustrative and that the scope of the claims is not limited to them. In general, techniques for using constructed diagnosis models to perform root cause analysis as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
in response to receipt of an indication of an event at a first component of a plurality of components in a system,
identifying a set of components from the plurality of components on which the first component depends;
retrieving a subset of a set of arithmetic circuits based on the subset of arithmetic circuits corresponding to component types of the first component and the set of components, wherein the set of arithmetic circuits comprises arithmetic circuits generated from a set of statistical models for a set of component types previously identified from the plurality of components, wherein the set of statistical models are generated from a system statistical model for the system, wherein each of the set of statistical models corresponds to a part of the system statistical model;
generating, using the subset of arithmetic circuits, a diagnosis model in accordance with dependencies among the first component and the set of components, wherein the first component and the set of components are each represented in the diagnosis model by an arithmetic circuit in the subset of arithmetic circuits; and
determining a root cause of the event at the first component based, at least in part, on evaluation the diagnosis model.

2. The method of claim 1 further comprising:
prior to receipt of the indication of the event at the first component,
determining component types of the plurality of components as the set of component types;
generating the set of statistical models from the system statistical model, wherein each of the set of statistical models corresponds to a component type of the set of component types and wherein the system statistical model has probability distributions for states of the plurality of components; and
generating the set of arithmetic circuits from the set of statistical models, wherein generating the set of arithmetic circuits comprises generating an arithmetic circuit from each of the set of statistical models.

3. The method of claim 2, wherein generating the set of statistical models from the system statistical model comprises:
for at least a first statistical model of the set of statistical models,
determining a first set of states for the first statistical model;
determining that a first component of a first component type corresponding to the first statistical model receives an input from a state of a second component of a second component type based, at least in part, on the system statistical model; and
indicating the first set of states and the state of the second component in the first statistical model.

4. The method of claim 2, wherein generating the set of arithmetic circuits from the set of statistical models comprises:
for at least a first arithmetic circuit of the set of arithmetic circuits,
determining a polynomial function based, at least in part, on states indicated in a statistical model from the set of statistical models;
creating the first arithmetic circuit based, at least in part, on the polynomial function; and
modifying the first arithmetic circuit to be a maximizer circuit, wherein modifying the first arithmetic circuit to be a maximizer circuit comprises substituting nodes which indicate an addition operation in the first arithmetic circuit with nodes which indicate a maximum operation.

5. The method of claim 1 further comprising:
prior to receipt of the indication of the event at the first component,
evaluating a first arithmetic circuit of the set of arithmetic circuits corresponding to a component type of the first component based, at least in part, on a set of potential state values; and
storing a result of evaluating the first arithmetic circuit along with the set of potential state values.

6. The method of claim 5, wherein determining the root cause of the event at the first component based, at least in part, on evaluation of the diagnosis model comprises:
retrieving a set of state values for the first component;
determining whether the set of state values matches the set of potential state values;
in response to determining that the set of state values does not match the set of potential state values, populating the first arithmetic circuit with the set of state values for evaluation of the diagnosis model; and
in response to determining that the set of state values matches the set of potential state values, retrieving the stored result of evaluating the first arithmetic circuit.

7. The method of claim 1, wherein generating, using the subset of arithmetic circuits, a diagnosis model in accordance with dependencies among the first component and the set of components comprises:
indicating a first arithmetic circuit of the subset of arithmetic circuits corresponding to a component type of the first component in the diagnosis model;
indicating a second arithmetic circuit of the subset of arithmetic circuits corresponding to a component type of a second component of the set of components in the diagnosis model;
determining that the second component affects the first component based, at least in part, on a relational schema which indicates the dependencies among the first component and the set of components; and
in response to determining that the second component affects the first component, linking, in the diagnosis model, an output of the second arithmetic circuit to an input of the first arithmetic circuit.

8. The method of claim 1, wherein retrieving the subset of the set of arithmetic circuits comprises:
for each of the first component and the set of components,
determining a component type for the component; and
in response to determining that an arithmetic circuit corresponding to the component type for the component has not been retrieved, retrieving the arithmetic circuit corresponding to the component type.

9. One or non-transitory more machine-readable storage media having program code for performing root cause analysis stored therein, the program code to:
identify a set of component types based, at least in part, on a system statistical model of a system having a plurality of components, wherein the system statistical model has probability distributions for states of the plurality of components;
generate a set of statistical models from the system statistical model, wherein each of the set of statistical models corresponds to a component type of the set of component types and each of the set of statistical models corresponds to a part of the system statistical model;
generate a set of arithmetic circuits from the set of statistical models, wherein the program code to generate the set of arithmetic circuits comprises program code to generate an arithmetic circuit from each of the set of statistical models;
in response to receipt of an indication of an event at a first component of the plurality of components in the system,
identify a set of components from the plurality of components on which the first component depends;
retrieve a subset of the set of arithmetic circuits based on the subset of arithmetic circuits corresponding to the component types of the first component and the set of components;
generate, using the subset of arithmetic circuits, a diagnosis model in accordance with dependencies among the first component and the set of components, wherein the first component and the set of components are each represented in the diagnosis model by an arithmetic circuit in the subset of arithmetic circuits; and
determine a root cause of the event at the first component based, at least in part, on evaluation of the diagnosis model.

10. The machine-readable storage media of claim 9, wherein the program code to generate the set of statistical models from the system statistical model comprises program code to:
for at least a first statistical model of the set of statistical models,
determine a first set of states for the first statistical model;
determine that a first component of a first component type corresponding to the first statistical model receives an input from a state of a second component of a second component type based, at least in part, on the system statistical model; and
indicate the first set of states and the state of the second component in the first statistical model.

11. The machine-readable storage media of claim 9, wherein the program code to generate the set of arithmetic circuits from the set of statistical models comprises program code to:
for at least a first arithmetic circuit of the set of arithmetic circuits,
determine a polynomial function based, at least in part, on states indicated in a statistical model from the set of statistical models;
create the first arithmetic circuit based, at least in part, on the polynomial function; and
modify the first arithmetic circuit to be a maximizer circuit, wherein the program code to modify the first arithmetic circuit to be a maximizer circuit comprises program code to substitute nodes which indicate an addition operation in the first arithmetic circuit with nodes which indicate a maximum operation.

12. The machine-readable storage media of claim 9, further comprising program code to:
prior to receipt of the indication of the event at the first component,
evaluate a first arithmetic circuit of the set of arithmetic circuits corresponding to a component type of the first component based, at least in part, on a set of potential state values; and
store a result of evaluating the first arithmetic circuit along with the set of potential state values.

13. An apparatus comprising:
a processor; and
a machine-readable medium having program code executable by the processor to cause the apparatus to,
in response to receipt of an indication of an event at a first component of a plurality of components in a system,
identify a set of components from the plurality of components on which the first component depends;
retrieve a subset of a set of arithmetic circuits based on the subset of arithmetic circuits corresponding to component types of the first component and the set of components, wherein the set of arithmetic circuits comprises arithmetic circuits generated from a set of statistical models for a set of component types previously identified from the plurality of components, wherein the set of statistical models are generated from a system statistical model for the system, wherein each of the set of statistical models corresponds to a part of the system statistical model;
generate, using the subset of arithmetic circuits, a diagnosis model in accordance with dependencies among the first component and the set of components, wherein the first component and the set of components are each represented in the diagnosis model by an arithmetic circuit in the subset of arithmetic circuits; and
determine a root cause of the event at the first component based, at least in part, on evaluation the diagnosis model.

14. The apparatus of claim 13 further comprising program code executable by the processor to cause the apparatus to:
prior to receipt of the indication of the event at the first component,
determine component types of the plurality of components as the set of component types;
generate the set of statistical models from the system statistical model, wherein each of the set of statistical models corresponds to a component type of the set of component types and wherein the system statistical model has probability distributions for states of the plurality of components; and
generate the set of arithmetic circuits from the set of statistical models, wherein the program code executable by the processor to cause the apparatus to generate the set of arithmetic circuits comprises program code executable by the processor to cause the apparatus to generate an arithmetic circuit from each of the set of statistical models.

15. The apparatus of claim 14, wherein the program code executable by the processor to cause the apparatus to generate the set of statistical models from the system statistical model comprises program code executable by the processor to cause the apparatus to:
for at least a first statistical model of the set of statistical models,
determine a first set of states for the first statistical model;
determine that a first component of a first component type corresponding to the first statistical model receives an input from a state of a second component of a second component type based, at least in part, on the system statistical model; and
indicate the first set of states and the state of the second component in the first statistical model.

16. The apparatus of claim 14, wherein the program code executable by the processor to cause the apparatus to generate the set of statistical models from the system statistical model comprises program code executable by the processor to cause the apparatus to:
for at least a first arithmetic circuit of the set of arithmetic circuits,
determine a polynomial function based, at least in part, on states indicated in a statistical model from the set of statistical models;
create the first arithmetic circuit based, at least in part, on the polynomial function; and
modify the first arithmetic circuit to be a maximizer circuit, wherein the program code executable by the processor to cause the apparatus to modify the first arithmetic circuit to be a maximizer circuit comprises program code executable by the processor to cause the apparatus to substitute nodes which indicate an addition operation in the first arithmetic circuit with nodes which indicate a maximum operation.

17. The apparatus of claim 13 further comprising program code executable by the processor to cause the apparatus to:
prior to receipt of the indication of the event at the first component,
evaluate a first arithmetic circuit of the set of arithmetic circuits corresponding to a component type of the first component based, at least in part, on a set of potential state values; and
store a result of evaluating the first arithmetic circuit along with the set of potential state values.

18. The apparatus of claim 17, wherein the program code executable by the processor to cause the apparatus to determine the root cause of the event at the first component based, at least in part, on evaluation of the diagnosis model comprises program code executable by the processor to cause the apparatus to:
retrieve a set of state values for the first component;
determine whether the set of state values matches the set of potential state values;
in response to a determination that the set of state values does not match the set of potential state values, populate the first arithmetic circuit with the set of state values for evaluation of the diagnosis model; and
in response to a determination that the set of state values matches the set of potential state values, retrieve the stored result of evaluating the first arithmetic circuit.

19. The apparatus of claim 13, wherein the program code executable by the processor to cause the apparatus to generate, using the subset of arithmetic circuits, a diagnosis model in accordance with dependencies among the first component and the set of components comprises program code executable by the processor to cause the apparatus to:
indicate a first arithmetic circuit of the subset of arithmetic circuits corresponding to a component type of the first component in the diagnosis model;
indicate a second arithmetic circuit of the subset of arithmetic circuits corresponding to a component type of a second component of the set of components in the diagnosis model;
determine whether the second component affects the first component based, at least in part, on a relational schema which indicates the dependencies among the first component and the set of components; and
in response to a determination that the second component affects the first component, linking, in the diagnosis model, an output of the second arithmetic circuit to an input of the first arithmetic circuit.

20. The apparatus of claim 13, wherein the program code executable by the processor to cause the apparatus to retrieve the subset of the set of arithmetic circuits comprises program code executable by the processor to cause the apparatus to:
for each of the first component and the set of components,
determine a component type for the component; and
in response to a determination that an arithmetic circuit corresponding to the component type for the component has not been retrieved, retrieve the arithmetic circuit corresponding to the component type.
